(19) United States
(12) Patent Application Publication
(10) Pub. No.: US 2007/0298970 A1
(43) Pub. Date: Dec. 27, 2007

(54) Method to reduce spray drift during application of pesticides and crop protection agents

(75) Inventors: Richard K. Mann, Franklin, IN (US); David L. Valcore, Carmel, IN (US); Raymond E. Boucher JR., Lebanon, IN (US); Toshiya Ogawa, Indianapolis, IN (US); Alan E. Haack, Roseville, CA (US); Deborah G. Shatley, Lincoln, CA (US)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 11/799,939

(22) Filed: May 3, 2007

Related U.S. Application Data
(60) Provisional application No. 60/797,097, filed on May 3, 2006.

(51) Int. Cl. A01N 25/24; A01N 25/04; A01P 13/00; A01P 3/00; A01P 7/04

(52) U.S. Cl. 504/362; 514/777

(57) ABSTRACT

Spray drift during the application of agricultural chemicals is reduced by incorporating a monosaccharide or a mixture of monosaccharides into the liquid to be sprayed and by spraying the resulting liquid through a flat fan or straight stream nozzle without a deflector. Average spray droplet sizes are increased and the percentage of driftable spray droplets (<150 microns) produced are reduced.

### BACKGROUND OF THE INVENTION

The present invention concerns a novel method to reduce spray drift during the application of agricultural chemicals by incorporating a monosaccharide or a mixture of monosaccharides into the liquid to be sprayed and by spraying the resulting liquid through a flat fan nozzle. Agricultural spraying by economical and available technologies uses hydraulic spray nozzles that inherently produce a wide spectrum of spray droplet sizes. A significant portion of spray droplets can be below 150 microns (μ) in diameter, which has been demonstrated in many field trials, wind tunnel testing and accepted math modeling to be drift-prone, i.e., many of the droplets are deposited significant distances off-target. Some herbicides have demonstrated very sensitive phytotoxicity to particular plant species at extremely low parts per million (ppm) or even parts per billion (ppb) levels, resulting in restricted applications around sensitive crops, orchards and residential plantings. For example, the California Dept of Pesticide Regulation imposes buffers of ½-2 miles for propanil containing herbicides applied aerially in the San Joaquin valley. Research has shown that commercially available drift retardants typically do not work with many aerially applied herbicide tank mixtures, due to pump shear, wind shear and other performance issues, which are more pronounced in high speed aerial application conditions. See Hewitt, A. J. (2003) Drift Control Adjuvants in Spray Applications: Performance and Regulatory Aspects. Proc. Third Latin American Symposium on Agricultural Adjuvants, Sao Paolo, Brazil.

### SUMMARY OF THE INVENTION

It has now been found that by incorporating a monosaccharide or mixture of monosaccharides into an agricultural spray mixture that spray drift during application can be reduced. The present invention concerns a method to reduce spray drift during the application of a pesticide which comprises a) incorporating into the pesticidal spray from about 0.1 to about 10 percent vol/vol of a monosaccharide or mixture of monosaccharides and b) spraying the resulting mixture through a flat fan (FF) or straight stream (SS) nozzle without a deflector. The reduction in spray drift may result from a variety of factors including a reduction in the production of fine spray droplets (<150 μ in diameter) and an increase in the volume median diameter (VMD) of the spray droplets.

### DETAILED DESCRIPTION OF THE INVENTION

The method to reduce spray drift applies to the application of any pesticide or crop protection agent including herbicides, fungicides and insecticides. Particularly preferred herbicides to which this method applies include cyhalofop-butyl, penoxsulam, flumetsulam, cloransulam-methyl, florasulam, pyroxsulam, diclosulam, fluroxypyr, clopyralid, acetochlor, triclopyr, isoxaben, 2,4-D, MCPA, MSMA, oxyfluorfen, oryzalin, trifluralin, aminopyralid, atrazine, picloram, tebuthiuron, pendimethalin, propanil and thiazopyr. Additional herbicides include 2,4-DB, acifluorfen, aclonifen, alachlor, amidosulfuron, aminotriazole, asulam, azimsulfuron, bensulfuron, bentazone, bispyribac-sodium, bromacil, bromoxynil, butachlor, butafenacil, butroxydim, cafenstrole, carfentrazone, chloridazon, chlorimuron, chlorsulfuron, cinidon-ethyl, cinosulfuron, clethodim, clodinafop, clomazone, cyanazine, cyclosulfamuron, cycloxydim, dicamba, dichlorprop, diclofop, diflufenican, diflufenzopyr, dimethachlor, dimethenamid, diquat, dithiopyr, diuron, ethalfluralin, ethofumesate, ethoxysulfuron, fenoxaprop, fentrazamide, flazasulfuron, fluazifop, flucarbazone, flufenacet, flufenpyr, flumiclorac-pentyl, flumioxazin, flupyrsulfuron, fomesafen, formasulfuron, fosamine, glufosinate, halosulfuron, haloxyfop, hexazinone, iodosulfuron, isoproturon, isoxaflutole, lactofen, linuron, MCPA-thioethyl, MCPB, mecoprop, mefenacet, mesosulfuron, mesotrione, metamitron, metazachlor, metolachlor, metosulam, metribuzin, metsulfuron, nicosulfuron, oxadiargyl, oxadiazon, oxasulfuron, oxazichlomefone, paraquat, phenmedipham, picloram, picolinafen, primisulfuron, profoxydim, propaquizafop, propoxycarbazone, propyzamide, prosulfuron, pyraflufen-ethyl, pyroxasulfone (KIH-485), pyrazolynate, pyrazosulfuron, pyribenzoxim, pyridate, pyriminobac-methyl, pyrithiobac, quinclorac, quinmerac, quizalofop, quizalofop-P-tefuryl, rimsulfuron, sethoxydim, simazine, sulcotrione, sulfentrazone, sulfometuron, sulfosate, sulfosulfuron, tefuryltrione (AVH-301), tembotrione (AE0172747) tepraloxydim, terbuthylazine, thifensulfuron, thiobencarb, topramezone, tralkoxydim, triasulfuron, tribenuron, trifloxysulfuron, triflusulfuron and tritosulfuron.

Particularly preferred insecticides to which this method applies include organophosphates such as chlorpyrifos, MAC's such as halofenozide, methoxyfenozide and tebufenozide, pyrethroids such as gamma-cyhalothrin and deltamethrin, and biopesticides such as spinosad and spinetoram. Additional insecticides include abamectin, acephate, acetamiprid, aldicarb, alpha-cypermethrin, bacillus thuringiensis, benfuracarb, bifenthrin, carbaryl, carbofuran, carbosulfan, cartap, chlorfenapyr, clothianidin, cyfluthrin, cypermethrin, diazinon, dichlorvos, dimethoate, emamectin, benzoote, endosulfan, esfenvalerate, fenitrothion, fipronil, flufenoxuron, indoxacarb, imidacloprid, lambda-cyhalothrin, lufenuron, malathion, methamidophos, methomyl, monocrotophos, novaluron, parathion-methyl, permethrin, phorate, profenophos, propargite, quinalphos, tefluthrin, terbufos, thiacloprid, thiametoxam, thiodicarb, triazophos, and zeta-cypermethrin.

Particularly preferred fungicides to which this method applies include mancozeb, myclobutanil, fenbuconazole, zoxamide, propiconazole, quinoxyfen and thifluzamide. Additional fungicides include azoxystrobin, benthiavalicarb, boscalid, captan, carbendazim, carboxin, carpropamid, chlorothalonil, copper fungicides, cyazofamid, cymoxanil, cyproconazole, cyprodinil, difenoconazole, dimethomorph, dinocap, epoxiconazole, ethaboxam, famoxadone, fenamidone, fenpropidin, fenpropimorph, fluazinam, fludioxonil, fluopicolide, fluoxastrobin, fluquinconazole, flusilazole, flutriafol, folpet, fosetyl, hexaconazole, iprodione, iprovalicarb, kresoxim-methyl, mandipropamid, maneb, meptyldinocap, metalaxyl, metconazole, metiram, metrafenone, orysastrobin, oxine-copper, picoxystrobin, probenazole, prochloraz, procymidone, propamocarb, propineb, prothioconazole, pyraclostrobin, pyrimethanil, spiroxamine, sulphur, tebuconazole, tetraconazole, thiophanate, thiram, triadimenol, tricyclazole, tridemorph, trifloxystrobin, zineb, and ziram.

Additional pesticides typically used as plant growth regulators to which this methodology applies include aminoethoxyvinyl glycine, chlormequat, cyclanilide, ethephon, flumetralin, flurprimidol, gibberellic acid, maleic hydrazide, mepiquat, paclobutrazol, prohexadione, thidiazuron, tributyl phosphorotrithioate and trinexapac-ethyl.

Monosaccharides used in the present invention are simple sugars, the best known of which are glucose, fructose, galactose and mannose. A particularly preferred and readily available mixture of monosaccharides useful in the method of the invention is invert sugar, a 50:50 mixture of glucose and fructose obtained by the hydrolysis of sucrose.

The monosaccharide or mixture of monosaccharides can be incorporated into the pesticidal spray by being tank-mixed directly with the diluted pesticidal formulation or by being provided as a pre-mix with the pesticidal formulation prior to dilution to the final spray volume. The monosaccharide or mixture of monosaccharides is incorporated at a concentration of about 0.1 to about 10 volume percent of the final spray volume.

The present method reduces off-target movement of the pesticide spray in both aerial and ground applications.

Narrow angle flat fan type nozzles, such as Spraying Systems Co. XR 4015 or 6515 series, or straight stream “jet” (plain orifice) type nozzles, such as Christopher Products CP-09 SS, are utilized in the present invention as opposed to deflector type nozzles.

### EXAMPLE 1

### Wind Tunnel Atomization

Aerodynamically engineered wind tunnels capable of uniform air velocities beyond the width of the nozzle spray plume are commonly used in the agricultural, forestry and other disciplines to accurately simulate atomizer performance and obtain droplet size results. The study utilized facilities and methods the US EPA has accepted for regulatory data (Hewitt, A. J. (1994) Measurement Techniques for Atomization Droplet Size Spectra Using Particle Size Analyzers in Wind Tunnels. SDTF Report T94-001, EPA MRID 43485603). The study was conducted under ASTM standards for laser diffraction drop size measurement and data reporting (ASTM E799 Standard Practice for Determining Data Criteria & Processing for Liquid Drop Size Analysis. American Soc. Testing & Materials, Race St., Philadelphia). Standard herbicide sprays containing cyhalofop plus crop oil were prepared according to label recommendations. Invert sugar as a 70% solution was added to the spray solutions which were well mixed. The solutions were applied through a Spraying Systems Co. XR 4015 or a Christopher Products CP-09 SS nozzle. The complete nozzle spray plume was traversed across the measurement laser beam for accurate data averaging. The methodology provides precise data with low percent standard deviation between replicates typically 3-4%

The results are summarized in Table 1.

TABLE 1
Cyhalofop Atomization with & without Invert Sugar

| | Invert | | Spray | | Rel. Span |
|---|---|---|---|---|---|
| | Sugar | Nozzle/Air | V.M.D | % fines | Dv_{0.9}- |
| Product | Rate | speed (mph) | μ | (% <150μ) | Dv_{0.1}/Dv_{0.5} |
| Aerial sprays | | | | | |
| Cyhalofop + AgriDex | 0 | XR-4015/120 | 526 | 2.7 | 2.16 |
| Crop oil | | | | | |
| Cyhalofop + AgriDex | 8 oz/10 gal | XR-4015/120 | 587 | 1.9 | 1.86 |
| Cropoil | | | | | |
| Cyhalofop + AgriDex | 0 | CP-09 SS | 528 | 4.6 | 2.37 |
| Crop oil | | | | | |
| Cyhalofop + AgriDex | 6 oz/10 gal | CP-09 SS | 551 | 3.7 | 1.79 |
| Crop oil | | | | | |

The results in Table 1 demonstrate the positive impact for reducing drift of spray droplets by increasing the VMD of the spray droplets by 11.6% and reducing the percentage of driftable fine droplets by 29.6% when invert sugar is added to the spray solution and Flat Fan XR-4015 nozzles are used to apply the solutions; and when using the CP-09-straight stream (SS) nozzles the VMD was increased by 4.4% and the percentage of driftable fine droplets was reduced by 19.6% when adding invert sugar to the spray solution.

We claim:

1. A method to reduce spray drift during the application of a pesticide which comprises a) incorporating into a pesticidal spray from about 0.1 to about 10 percent vol/vol of a monosaccharide or mixture of monosaccharides and b) spraying the resulting mixture through a flat fan or straight stream nozzle without a deflector.

2. The method of claim 1 in which the pesticide is an herbicide.

3. The method of claim 2 in which the herbicide is cyhalofop-butyl, penoxsulam, flumetsulam, cloransulam-methyl, florasulam, pyroxsulam, diclosulam, fluroxypyr, clopyralid, acetochlor, triclopyr, isoxaben, 2,4-D, MCPA, MSMA, oxyfluorfen, oryzalin, trifluralin, aminopyralid, atrazine, picloram, tebuthiuron, pendimethalin, propanil, thiazopyr, 2,4-DB, acifluorfen, aclonifen, alachlor, amidosulfuron, aminotriazole, asulam, azimsulfuron, bensulfuron, bentazone, bispyribac-sodium, bromacil, bromoxynil, butachlor, butafenacil, butroxydim, cafenstrole, carfentrazone, chloridazon, chlorimuron, chlorsulfuron, cinidon-ethyl, cinosulfuron, clethodim, clodinafop, clomazone, cyanazine, cyclosulfamuron, cycloxydim, dicamba, dichlorprop, diclofop, diflufenican, diflufenzopyr, dimethachlor, dimethenamid, diquat, dithiopyr, diuron, ethalfluralin, ethofumesate, ethoxysulfuron, fenoxaprop, fentrazamide, flazasulfuron, fluazifop, flucarbazone, flufenacet, flufenpyr, flumiclorac-pentyl, flumioxazin, flupyrsulfuron, fomesafen, formasulfuron, fosamine, glufosinate, halosulfuron, haloxyfop, hexazinone, iodosulfuron, isoproturon, isoxaflutole, lactofen, linuron, MCPA-thioethyl, MCPB, mecoprop, mefenacet, mesosulfuron, mesotrione, metamitron, metazachlor, metolachlor, metosulam, metribuzin, metsulfuron, nicosulfuron, oxadiargyl, oxadiazon, oxasulfuron, oxazichlomefone, paraquat, phenmedipham, picloram, picolinafen, primisulfuron, profoxydim, propaquizafop, propoxycarbazone, propyzamide, prosulfuron, pyraflufen-ethyl, pyroxasulfone (KIH-485), pyrazolynate, pyrazosulfuron, pyribenzoxim, pyridate, pyriminobac-methyl, pyrithiobac, quinclorac, quinmerac, quizalofop, quizalofop-P-tefuryl, rimsulfuron, sethoxydim, simazine, sulcotrione, sulfentrazone, sulfometuron, sulfosate, sulfosulfuron, tefuryltrione (AVH-301), tembotrione (AE0172747) tepraloxydim, terbuthylazine, thifensulfuron, thiobencarb, topramezone, tralkoxydim, triasulfuron, tribenuron, trifloxysulfuron, triflusulfuron or tritosulfuron.

4. The method of claim 2 in which the herbicide is cyhalofop-butyl, penoxsulam, flumetsulam, cloransulam-methyl, florasulam, pyroxsulam, diclosulam, fluroxypyr, clopyralid, acetochlor, triclopyr, isoxaben, 2,4-D, MCPA, MSMA, oxyfluorfen, oryzalin, trifluralin, aminopyralid, atrazine, picloram, tebuthiuron, pendimethalin, propanil or thiazopyr.

5. The method of claim 1 in which the pesticide is an insecticide.

6. The method of claim 5 in which the insecticide is chlorpyrifos, halofenozide, methoxyfenozide, tebufenozide, gamma-cyhalothrin, deltamethrin, spinosad, spinetoram, abamectin, acephate, acetamiprid, aldicarb, alpha-cypermethrin, bacillus thuringiensis, benfuracarb, bifenthrin, carbaryl, carbofuran, carbosulfan, cartap, chlorfenapyr, clothianidin, cyfluthrin, cypermethrin, diazinon, dichlorvos, dimethoate, emamectin, benzoote, endosulfan, esfenvalerate, 20 fenitrothion, fipronil, flufenoxuron, indoxacarb, imidacloprid, lambda-cyhalothrin, lufenuron, malathion, methamidophos, methomyl, monocrotophos, novaluron, parathion-methyl, permethrin, phorate, profenophos, propargite, quinalphos, tefluthrin, terbufos, thiacloprid, thiametoxam, thiodicarb, triazophos, or zeta-cypermethrin.

7. The method of claim 5 in which the insecticide is chlorpyrifos, halofenozide, methoxyfenozide, tebufenozide, gamma-cyhalothrin, deltamethrin, spinosad or spinetoram.

8. The method of claim 1 in which the pesticide is a fungicide.

9. The method of claim 8 in which the fungicide is mancozeb, myclobutanil, fenbuconazole, zoxamide, propiconazole, quinoxyfen, thifluzamide, azoxystrobin, benthiavalicarb, boscalid, captan, carbendazim, carboxin, carpropamid, chlorothalonil, copper fungicides, cyazofamid, cymoxanil, cyproconazole, cyprodinil, difenoconazole, dimethomorph, dinocap, epoxiconazole, ethaboxam, famoxadone, fenamidone, fenpropidin, fenpropimorph, fluazinam, fludioxonil, fluopicolide, fluoxastrobin, fluquinconazole, flusilazole, flutriafol, folpet, fosetyl, hexaconazole, iprodione, iprovalicarb, kresoxim-methyl, mandipropamid, maneb, meptyldinocap, metalaxyl, metconazole, metiram, metrafenone, orysastrobin, oxine-copper, picoxystrobin, probenazole, prochloraz, procymidone, propamocarb, propineb, prothioconazole, pyraclostrobin, pyrimethanil, spiroxamine, sulphur, tebuconazole, tetraconazole, thiophanate, thiram, triadimenol, tricyclazole, tridemorph, trifloxystrobin, zineb, and ziram.

10. The method of claim 8 in which the fungicide is mancozeb, myclobutanil, fenbuconazole, zoxamide, propiconazole, quinoxyfen or thifluzamide.

11. The method of claim 1 in which the pesticide is a plant growth regulator.

12. The method of claim 11 in which the plant growth regulator is aminoethoxyvinyl glycine, chlormequat, cyclanilide, ethephon, flumetralin, gibberellic acid, maleic hydrazide, mepiquat, paclobutrazol, prohexadione, thidiazuron, tributyl phosphorotrithioate or trinexapac-ethyl.

13. The method of claim 1 in which monosaccharides or mixture of monosaccharides is invert sugar.
